(19) United States
(12) Patent Application Publication
(10) Pub. No.: US 2020/0211035 A1
(43) Pub. Date: Jul. 2, 2020

(54) LEARNING SYSTEM FOR CURING USER ENGAGEMENT

(71) Applicant: Microsoft Technology Licensing, LLC, Redmond, WA (US)

(72) Inventors: Jason Bluming, Redmond, WA (US); Avleen S. Bijral, Redmond, WA (US); Amrita Ray, Palo Alto, CA (US); Yan Guo, Medina, WA (US); Xin Deng, Kirkland, WA (US)

(21) Appl. No.: 16/237,339

(22) Filed: Dec. 31, 2018

(51) Int. Cl. G06Q 30/02; H04L 29/08; G06N 20/00

(52) U.S. Cl. CPC G06Q 30/0201; G06N 20/00; H04L 67/306; H04L 67/22

(57) ABSTRACT

Disclosed are methods and systems for generating cure actions for improving a level of user engagement of a network. In some aspects, a method includes identifying network interaction relationships among a plurality of accounts of a computer network based on communication flows among the accounts, and tracking a level of engagement health of each of the accounts based on the interaction relationships over time. For each of the accounts, a determination is made as to whether the tracked level of engagement health meets a threshold requirement. For an account having a level of engagement health not meeting the threshold requirement, a cure action is selected based on one or more rules relating the tracked level of engagement health of the account to one or more predefined criteria. The cure action is then applied to the account.

### BACKGROUND

Data mining is being used extensively to obtain insights into business functions. Of course, these insights are only as good as the data upon which they are based. Thus, it is important to capture metrics that map to the value being created by the system under examination. Selection of the right metrics may be governed by well defined criterion, such as the durability, scalability, actionability, validity and simplicity of the metrics.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is an overview diagram showing user data flows over a computer network.

FIG. 2 shows an example graph data structure representing data flow between users and/or user accounts or devices that may be implemented in one or more of the disclosed embodiments.

FIG. 3 illustrates a data flow that may be implemented in one or more of the disclosed embodiments.

FIG. 4A shows an example of data structures that may be implemented at least some of the disclosed embodiments.

FIG. 4B shows an example of data structures that may be implemented at least some of the disclosed embodiments.

FIG. 5A shows an example machine learning module according to some examples of the present disclosure.

FIG. 5B shows an example block diagram including components used to train a model.

FIG. 6 shows an expanded data flow that may be implemented in at least some embodiments.

FIG. 7 is a flowchart of one example method for classifying a user.

FIG. 8 is a flowchart of one example method for periodically classifying a user.

FIG. 9 is a flowchart of an example method for applying a cure action to a user or a user account.

FIG. 10 is a flowchart of an example method for applying a cure action to a user or a user account.

FIG. 11 illustrates a block diagram of an example machine upon which any one or more of the techniques (e.g., methodologies) discussed herein may perform.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

Corporate networks are typically fixed, such that users are inherently reachable. Data analysis methods may be fairly static, and focus on the health of the physical network. Available bandwidth, latency, response time, connection reliability, and connectivity type metrics may be used heavily in this type of analysis. While data analysis based on network level metrics may do a fair job at predicting the relative health of the physical network, they are not good predictors of the health of network applications built on top of those networks. Thus, when attempting to understand the health of network applications, such as a network telephony or messaging communication application or a social network, a technical problem is presented when using network data analysis tools, as challenges specific to the network application domain may not to be considered sufficiently by these analysis methods. Thus, the results of these analysis methods may not provide a clear vision of the challenges occurring at the network application level. For example, users may join and leave a network application such as a social network or telephony application. Analyzing packet level communication may not provide insight into which users are joining or leaving the network, and fundamental parameters underlying that user behavior. It may thus be challenging or even impossible to understand connections between users of a social network by analyzing packet level communications.

One solution to this technical problem is first a recognition that in communication networks, the value of the network to each user is very much dependent on whether each user's personal network contacts are reachable via the communication network. The breadth and health of the network makes it attractive to users. Furthermore, usage by the users themselves increases the value and health of the network. This realization implies that focusing on individual users will not be effective, and instead, a study of individual users and their engagement with other users, via the network in question is necessary.

Many existing network application key performance indicators (KPIs) focus on an individual user, and thus may fail to account for the network dynamics in a communication application. For example, automated targeting solutions use user profile information or segmentations to select users for engagement.

In contrast, the disclosed embodiments provide a technical solution to the problem described above by dynamically tracking communications activity at the application and/or user level. For example, the disclosed embodiments may differentiate a static “contact” list with contacts engaged in active communications. This strategy provides the advantage of recency, common context, and may utilize information on the intent and direction (e.g. which user initiated, how often they initiated, with which user they initiated, and in what order they initiated) communications. Communications flows can be recurrent or not, but they reflect different patterns during work and personal activities, and differ by device type and location. As such, they are an implicit proxy for user-graph recency and clustering. Depending on the window of time used, the changes in connection flow also reflect per-topic and/or contextual trends as well.

Some solutions may employ artificial intelligence and targeting via market targeting tools that characterize individuals/cohorts and then run a “treatment” of AA/AB tests against control and a subset to gauge effectiveness. In contrast, the disclosed embodiments were developed by testing the effectiveness of each proposed treatment across machine learning (ML)-selected users (for example, “users likely to churn”), we can characterize (via ML or the like) what further characteristics/attributes/behaviors of users tend to respond best to each treatment. This may then influence future targeting.

Thus, by modelling the communications flows between users, the disclosed embodiments provide a model that not only has stronger predictive power for network performance, but can be used to identify both individual (and group) risks and opportunities to target for both in-app and external (through marketing) targeting, increasing overall network health/decreasing loss. This extends to multiple orders (friends of friends, etc.) and indirect connections (mutual friends). By testing multiple “cures”, we can automate the process of test, target, and apply cure on a per-user/group basis and automate/speed/improve the management of the network.

By combining these approaches, the disclosed embodiments provide a network-based analytical model with ML-derived targeting models (ie. “at risk”, “most influential”, “best acquirers”, etc.). A test/validation for scoring approach is then employed which creates a new target-treatment alignment list.

One insight that assisted in designing the disclosed embodiments was the realization that data networks share many properties with biological systems. Thus, the disclosed embodiments leverage expertise in related disciplines: epidemiology, graph theory, flow modelling, and econometrics. These areas include computation of interactions between massive numbers of simple entities created complex graphs of information.

The network may be characterized much like an organism, with context including network span (number of connections from each node to other nodes or leaves, or shortest path distances), network cohesion (robustness of network connections to changes in nodes or signal patterns), network density (distributed of connectivity/span throughout the network, which may be represented via a clustering coefficient), propensity to churn, and flow models (looking for sources of information and sinks—those who tend to send more information, receive more information, create conversation connections, or get connected-to for example).

While analyzing communication networks, there was some perception that many loyalist users were also infrequent users (holidays, occasions, weekends), the graph revealed that a significant number of Skype users were connected regularly only to one other user (with level of engagement linked to higher connectivity as expected). Identifying this risk as a call to action, a network graph was used to create a predictive model of user retention for which connection frequency, type, direction, and target were included in the inputs. By feeding the graph model with all communication flows over a previous period of time (e.g. a year), the model was trained to look for user activity drop-off and predict future churn based on past communication behaviors.

To measure levels of user engagement, the users may be classified based on a number of completed circuits the user participates in over a time period may be used. For example, a classifications may be reserved for users averaging one circuitry per week, three circuits per week, three circuits per day for at least four days per week, or three circuits per week at least every other days. The model may track users over multiple time periods. For example, some embodiments implement a “3×3” model This example model tracks a cohort of users at 7, 30, and 90 day intervals to determine their relative engagement levels before and after the period.

To validate the model, users predicted by the model to leave the network were exposed to a messaging campaign. This messaging campaign included users judged by the model to be at-risk. These users received either an in-application notification or a campaign notice. Users that received in-application messaging shoed a 3× reduction in churn (e.g. dormancy of use of the network). Users who received in campaign notice showed a 5× reduction in churn (dormancy of use of the network) in a time period after the initiative began (e.g. 30 days).

From these experiments, we conclude the engaged user model is an effective metric for improving network graph. We further conclude that using network graph modeling to build predictive behavior models is an effective tool for targeting. Targeting an individual for campaign activity based on network dynamics has the potential to provide significant value, especially given the frequency and volume of communication on some of the targeted networks.

The disclosed embodiments also leverage these learning models to provide for self-healing capabilities for the network. The network graph model can receive network communication flow information and classify users via a learned classifier. Application of cure actions to particular users classified by the model may be automated by the disclosed embodiments, creating a virtual immune system for the network. This results in automatic targeting of at-risk users for retention or revenue increase via in-application activities stimulated by results of the classifier.

This approach may be applied to solve other problems besides, for example, user churn or dormancy by changing the equation the model is optimizing. For example, while the model was initially developed to reduce user churn, by changing the equation optimized by the model, the model may generate actions that drive improved revenue provided by the network. For example, the model may be applied to cross-product drivers of usage and adoption. Just as the churn model tracked factors that led users to disengage from use of the network, other models lead to new consumer product trials, adoption, and referral improvements.

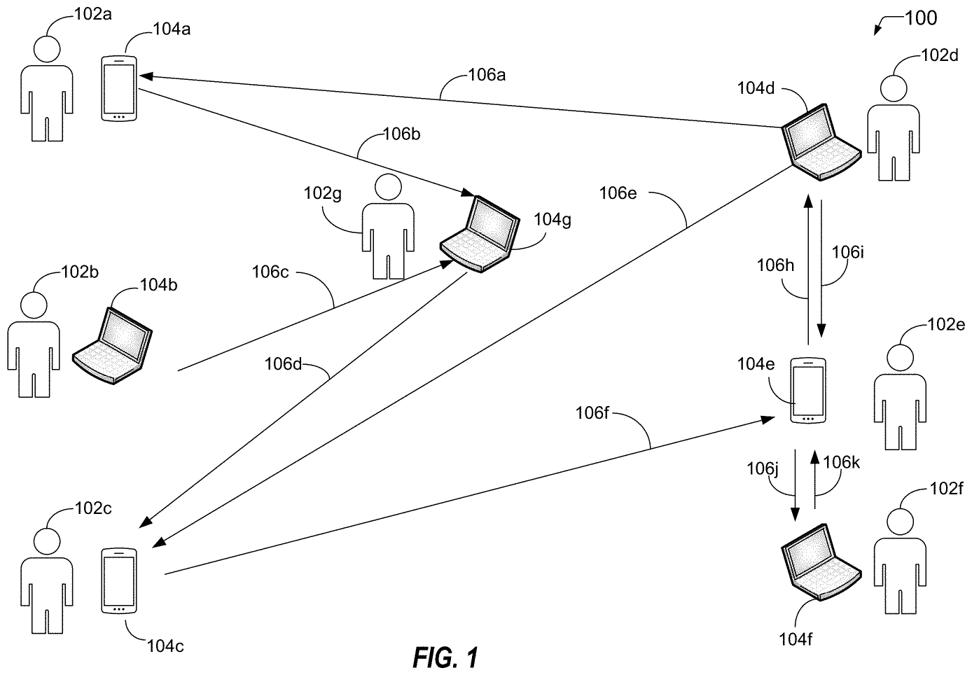

FIG. 1 is an overview diagram showing data flows generated by users of a computer network. FIG. 1 shows seven example users 102a-g, associated with seven corresponding devices 104a-g. These users, 102a-g, are in communication with each other via their corresponding devices 104a-g. The communication is represented by communication flows 106a-g. One of skill would understand that the users 102a-g, devices 104a-g, and communication flows 106a-g are just examples, and the disclosed embodiments may operate on computer networks including fewer or more of each of users, devices, and communication flows.

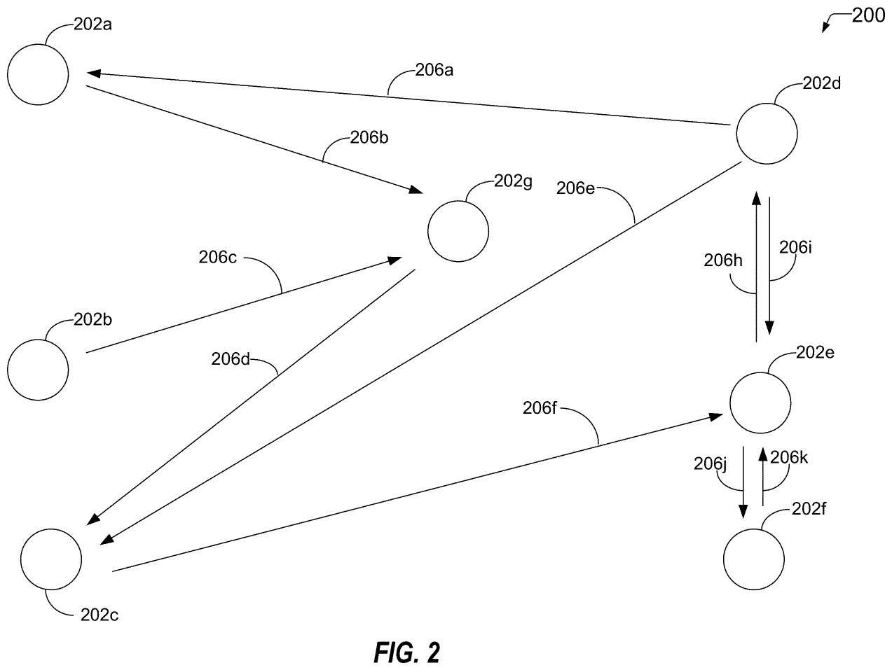

FIG. 2 shows an example graph data structure 200 that may be implemented in one or more of the disclosed embodiments. The graph data structure 200 may be constructed to represent user activity on the computer network 100 discussed above with respect to FIG. 1. The graph 200 includes nodes 202a-g. Each of the nodes 202a-g represents one of the users 102a-g. In some aspects, the nodes 202a-g may represent one or more of the users 102a-g, devices 102a-g, or user accounts for each of the users 102a-g. The communication flows 106a-k of FIG. 1 are represented by edges 206a-k of the graph 200. In some aspects, one or more of the edges 206a-k may represent a single message flowing from a source node (representing one or more of a user/device/account) to a destination node (representing one or more of a user/device/account). Note that the edges may be directional, in that they specifically indicate a source node and a destination node for one or more communication flows. In some other aspects, an edge may simply represent that communication has flowed in either direction between two nodes. Counts of messages associated with each direction may then be associated with each node to provide directional information. The graph 200 may be implemented as a series of data structures in various embodiments, as discussed below.

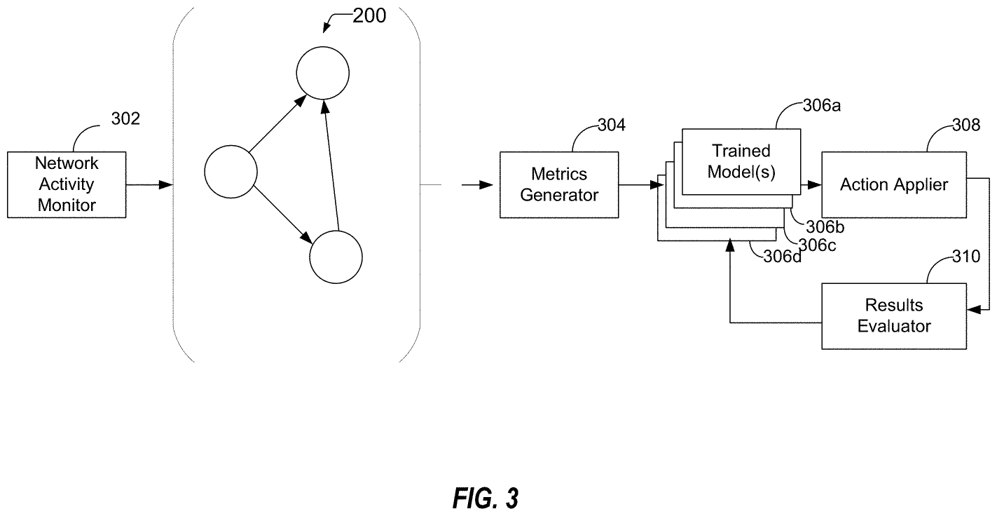

FIG. 3 illustrates a data flow that may be implemented in one or more of the disclosed embodiments. FIG. 3 shows a network activity monitor 302, graph 200, metrics generator 304, trained model 306a-d, an action applier 308, and a results evaluator 310. The network activity monitor 302 may monitor activity on the computer network 100. For example, the network activity monitor may detect one or more of the devices 104a-g and communication flows 106a-k. In some aspects, the detection may be accomplished via integration with a software application running on each of the devices 104a-g. In these aspects, the software application (not shown in FIG. 1) may send information to the network activity monitor 302 indicating one or more of the users 102a-g (such as information identifying a user account of the user), devices 104a-g, or user accounts associated with the users 102a-g. The network activity monitor 302 may also identify a time when one or more of the communication flows 106a-k occurs. The network activity monitor 302 may generate the graph 200 based on the detected activity.

The metrics generator 304 may generate one or more metrics based on the graph 200. In various aspects, one or more of a network span (number of connections from each node to other nodes or leaves), network cohesion (robustness of network connections to changes in nodes or signal patterns), and network density (distribution of connectivity/span throughout the network. The metrics generator 304 may classify one or more nodes 204a-g as a source or a sink of connections, based on a ratio between a number of flows into and out of a node. Metrics indicating one or more of connection frequency of a node, type of connections, and direction of connections may also be generated.

The trained model 306a-d is provided one or more metrics generated by the metrics generator 304. In some aspects, the trained model 306a-d may be based on a neural network, such as a convolutional neural network (CNN). The training of the model 306 is described in more detail below. The trained model 306a-d may output a one or more cure actions based on the input metrics. The trained model 306a-d may receive input from the results evaluator 310, discussed in more detail below, and adapt internal weights that map particular user characteristics and behaviors to cure actions. Thus, the trained model 306a-d is able to learn which cure actions are most effective for particular types of users (those having particular characteristics), and apply those cure actions to other users having similar characteristics. The trained model 306a-d is shown as multiple rectangles in FIG. 3, to illustrate an ability of the trained model to learn and physically change over time. For example, as the results evaluator 310 provides input on an effectiveness of one or more cure actions applied based on output of the trained model 306a-d, the trained model may change its internal mappings and weights that control which cure actions are applied under which conditions and with particular users having particular sets of characteristics. Thus, each of the rectangles 306a, 306b, 306c, and 306d, represents a different “trained state” of the model 306a-d, each of the trained states including different mappings between user characteristics, network conditions, and cure actions to be applied.

The results evaluator 310 may be configured to drive optimization of a variety of equations that result in particular improvements sought by application of the disclosed embodiments. For example, in some embodiments, the results evaluator 310 may provide data back to the model that causes the model to optimize user engagement and disfavors user dis-engagement. In other embodiments, the results evaluator 310 may be configured to provide data back to the model that causes the model to optimize revenue generated by the network.

The action applier 308 may apply one or more of the cure actions (e.g. 454) identified by the trained model(s) 306a-d. The action applier 308 may invoke a variety of actions, such as messaging a particular user account, prioritizing traffic for the user account, or improving network performance experienced by a particular user by changing a traffic route through a network for traffic sourced by or destined for the user's account. Messaging of the user may be achieved using a variety of technologies, including email, text message, or messaging functions of one or more social network applications (e.g. Skype®, etc). The messages may include a reminder that a user has an unread message from a second user. Some embodiments may send a message including a recommendation for a first user to contact a second user. This message may be generated after analyzing communication between the first user and a second user to detect a pattern of communication. For example, a pattern of communication may be detected that the two users communicate at least every n days. Based on the detection of the pattern, if no communication between the two users is detected within n+C days (with C being a contact value) or n*1.p days (with p representing a percentage), the recommendation message may be initiated.

Some embodiments may send one or more messages indicating one or more of a prompt to check messages, or resend a message. Some embodiments may send pop-ups or notifications to a user's device or multiple devices of a user, prompt a friend or network colleague to take an action, place time on a user's calendar to call back a second user, reach out to an alternative user or group on another user's behalf, initiate shared scheduling, and/or create a shared task.

The results evaluator 310 evaluates effects of the cure actions applied via the action applier 308. For example, the results evaluator 310 may generate a mapping between a cure action applied to a particular level, and an effect on a measured level of the user's level of engagement. The results evaluator may also map multiple characteristics of the user to which the cure action was applied, and include this in the mapping. Thus, the results evaluator 310 generates a mapping that identifies relatively specific user characteristics, a cure action, and how effective that cure action was on that particular user with the specific user characteristics. Thus, for example, when a cure action is particular effective with users within a first age range, this data may not be probative on the possible effect on users within a second age range. By maintaining a mapping between not only a cure action and an effect on a particular user, but also on multiple characteristics of that particular user, a model of user behavior may successfully differentiate between multiple cure actions with varying levels of effectiveness across a broad variety of users having different characteristics.

Each of the network activity monitor 302, metrics generator 304, trained models 306a-d, action applier 308, and results evaluator 310 may represent sets of instructions that configure hardware processing circuitry to perform one of the functions attributed to them above.

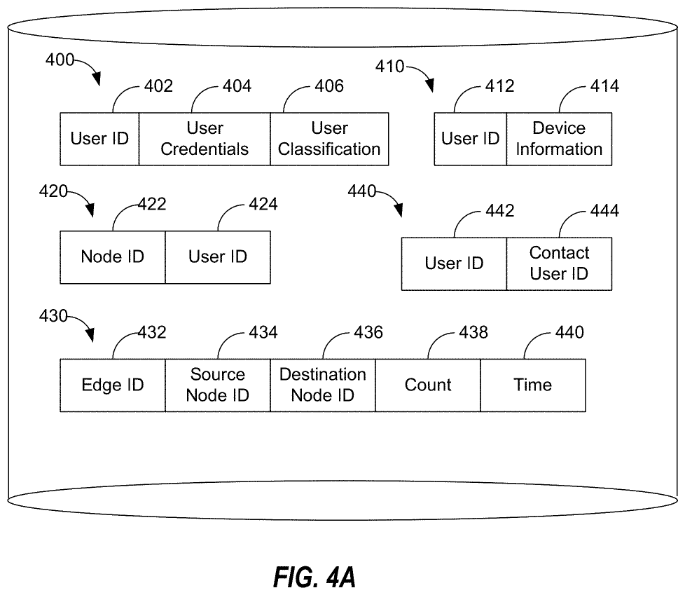

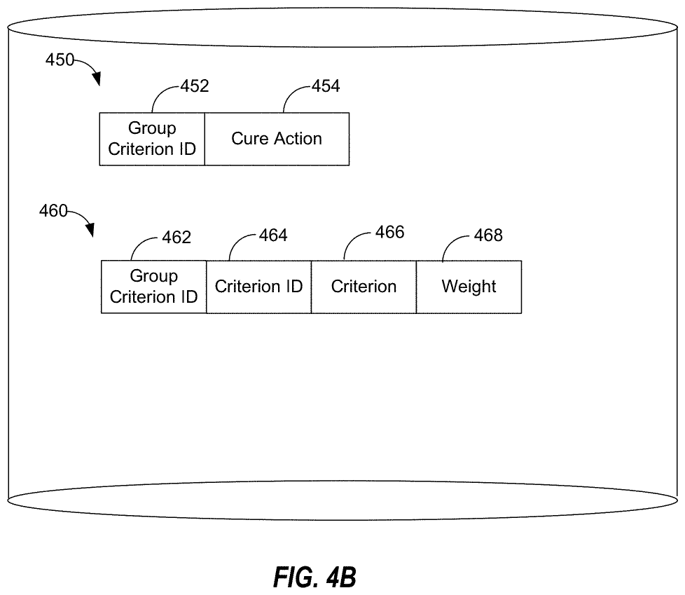

FIG. 4A shows an example of data structures that may be implemented at least some of the disclosed embodiments. As described below, the data structures shown in FIG. 4A are implemented as relational database table, with each structure representing a row in said table. Alternatively, the data structures could be implemented in other manners, such as using traditional memory based data structures such as linked lists, tree, or other structures that may be flushed to a stable storage device as needed.

FIG. 4A shows a user table 400, device table 410, node table 420, and edge table 430, and a contact table 440. The user table 400 includes a user identifier 402 user credentials 404, and a user classification 406. The user identifier 402 may uniquely identify a user (e.g. 102a-g). The user credentials 404 may include one or more of a user account name and user account password. The user credentials 404 may provide for a session to be established for a user account associated with the user identified by the user identifier 402. The user classification may store a classification for a user. For example, some embodiments may classify users as either leaders or non-leaders. This classification may be stored in the field 406. The classification may be used to determine a set of rules to be applied to a engagement health assessment of the user.

The device table 410 includes a user identifier 412 and device information 414. The device information 414 may identify one or more attributes of a device (e.g. 104a-g) associated with a user (e.g. 102a-g) identified by the user identifier 412. For example, the attributes may include a media access control address of the device, IP address, network host name of the device, operating system version of the device, or other device attributes.

The node table 420 includes a node identifier 422 and user identifier 424. The node identifier uniquely identifies a node in a graph (e.g., 202a-g). The user identifier 424 uniquely identifies a user (e.g. 102a-g) represented by the node. In some aspects, the node table may instead include a device identifier when the node represents a device instead of the user. In some aspects, the node may represent the user account of the user. Representing the user or the user account may be synonymous.

The edge table 430 includes an edge identifier 432, source node identifier 434, destination node identifier 436, count 438, and a time 440. The edge identifier 432 uniquely identifies an edge (e.g. 206a-k) connecting two nodes in a graph (e.g. 200). The source node identifier 434 identifies a source of a communication flow (e.g. 106a-k) in a network (e.g. 100) represented by a graph (e.g. 200). As an example, node 202c is a source of edge 206f in FIG. 2. The destination node identifier 436 uniquely identifies a destination node for a communication flow in a network (e.g. 100) represented by a graph (e.g. 200). An example node 202e is a destination node of edge 206f. Note that edge 206f represents communication flow 106f, which flows from device 104c (represented by node 202c of FIG. 2) to device 104e (represented by node 202e of FIG. 2).

The contact table 440 stores relationships between users. A first user id 442 identifies which user this entry in the contact table 440 pertains to. In other words, the user id 442 identifies a user with a contact. The contact user id 444 identifies the contact. The contact table 440 may be used by some embodiments to identify a number of users that are reachable by another particular user via the network 100, as discussed below.

FIG. 4B shows an example of data structures that may be implemented at least some of the disclosed embodiments. As described below, the data structures shown in FIG. 4B are implemented as relational database table, with each structure representing a row in said table. Alternatively, the data structures could be implemented in other manners, such as using cloud based data stores, profile stores, data warehouses, and/or traditional memory based data structures such as linked lists, tree, or other structures that may be flushed to a stable storage device as needed.

FIG. 4B shows a rules table 450 and a criterion table 460. The rules table 450 includes a group criterion identifier 452, and a cure action 454. The group criterion identifier 452 identifies one or more criterion that may be evaluated to determine whether to apply the cure action defined by cure action 454. The cure action 454 may identify one or more physical actions. For example, the cure action 454 may define a first action of sending a particular type of email message and a second action of changing a user interface presented to the user. If the criterion identified by the group criterion identifier 452 are met, then the disclosed embodiments perform the one or more physical cure actions defined by the cure action 454.

The criterion table 460 identifies criterion that are evaluated when determining whether to apply the cure actions identified by the cure action 454. The group criterion identifier 462 identifies one or more criterion and may be cross referenced with the group criterion identifier 452. The criterion identifier 464 uniquely identifies a particular criterion. The criterion field 466 stores data defining a criterion (e.g. engagement health level drops two levels over a time period). The weight field 468 stores a weight value for the criterion 466. In some aspects, if a criterion 466 is satisfied, the weight 468 may be used to determine a weight of a cure action associated with the criterion via the group criterion id 462/452. The weight 468 may be modified in some aspects based on results of the cure action 454. For example, if a cure action 454 is effective, the weight 468 may be increased, and vi s-versa.

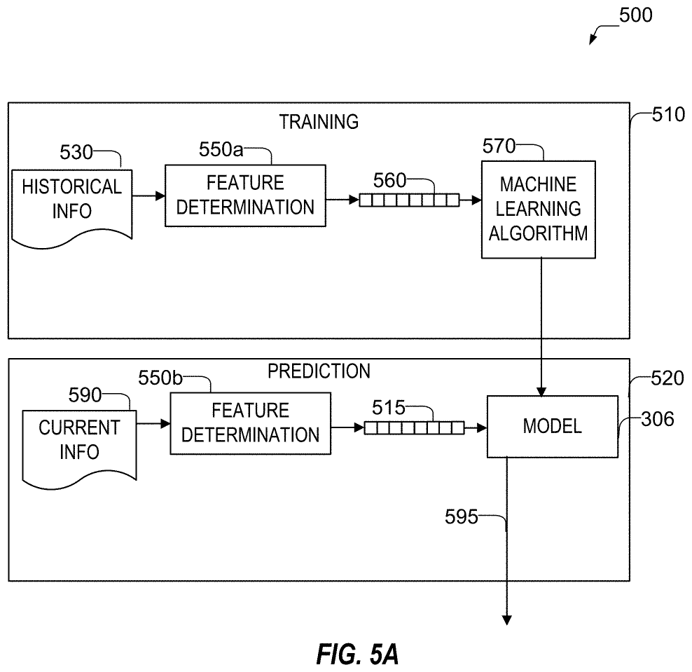

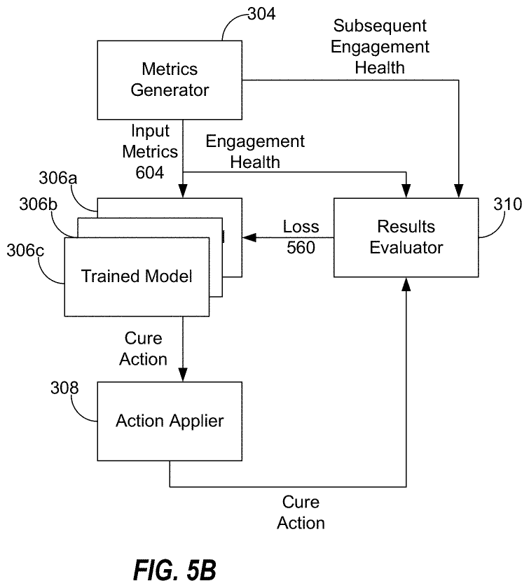

FIG. 5A shows an example machine learning module 500 according to some examples of the present disclosure. Machine learning module 500 utilizes a training module 510 and a prediction module 520. Training module 510 inputs historical information 530 into feature determination module 550a. The historical information 530 may be labeled. Example historical information may include text or statements stored in a training library of text or statements. Labels may indicate portions of the text or statements that provide assertions.

Feature determination module 550a determines one or more features 560 from this historical information 530. Stated generally, features 560 are a set of the information input and is information determined to be predictive of a particular outcome. In some examples, the features 560 may be all the historical activity data, but in other examples, the features 560 may be a subset of the historical activity data. The machine learning algorithm 570 produces a model 306 (e.g. any of 306a-d of FIG. 3) based upon the features 560 and the label.

In the prediction module 520, current information 590 may be input to the feature determination module 550. Feature determination module 550b may determine the same set of features or a different set of features from the current information 590 as feature determination module 550a determined from historical information 530. In some examples, feature determination module 550a and 550b are the same module. Feature determination module 550b produces feature vector 515, which is input into the model 306 to generate a likelihood of response score 595. The training module 510 may operate in an offline manner to train the model 306. The prediction module 520, however, may be designed to operate in an online manner. It should be noted that the model 306 may be periodically updated via additional training and/or user feedback.

The machine learning algorithm 570 may be selected from among many different potential supervised or unsupervised machine learning algorithms. Examples of supervised learning algorithms include artificial neural networks, Bayesian networks, instance-based learning, support vector machines, decision trees (e.g., Iterative Dichotomiser 3, C4.5, Classification and Regression Tree (CART), Chi-squared Automatic Interaction Detector (CHAID), and the like), random forests, linear classifiers, quadratic classifiers, k-nearest neighbor, linear regression, logistic regression, hidden Markov models, models based on artificial life, simulated annealing, and/or virology. Examples of unsupervised learning algorithms include expectation-maximization algorithms, vector quantization, and information bottleneck method. Unsupervised models may not have a training module 510. In an example embodiment, a regression model is used and the model 580 is a vector of coefficients corresponding to a learned importance for each of the features in the vector of features 560, 515. To calculate a score, a dot product of the feature vector 515 and the vector of coefficients of the model 306 is taken.

FIG. 5B shows a block diagram including components that may train the model 306. FIG. 5B shows that metrics 604 generated by the metrics generator 304, such as a level of engagement health, which are provided to the trained model 306. The metrics 604 may be generated for each user account or user evaluated by the disclosed embodiments. For each user, the input metrics for the model may include a wide variety of data that characterize the user and the user's experience on the network. This may include one or more of the users age, gender, education, a user's location history (e.g. locations that user has resided over a defined period of time), user's current location, a list of devices the user typically uses to access the network applications, and/or a device type for each device in the list (e.g. mobile, laptop, desktop, etc), indications of whether the user communicates via text, email, video, chat, or other mechanism, and/or a proportion of each of these techniques the user utilizes, a list of first other users the user receives messages from (within a previous defined time period), and a frequency of correspondence with each of those users, a second list of second other user's the user sends messages to (within a second defined time period) (and a frequency of messaging with each of those users), times of day associated with sending and/or receiving of the messages to the other users, a coherence measurement in communication flows between the user and each of the other users. By providing a multi-dimensional vector of user characteristics to a model, the model may be able to establish relationships between subsets of these user characteristics and particular cure actions that are more effective with users having the subset of characteristics. Thus, the model can not only, for example, differentiate sets of cure actions for each of groups of users having different age ranges, but may differentiate groups of cure actions for each of groups of users having commonality across 2, 3, 4, 5, 7, 8, 9, 10 or any number of dimensions. Thus, the cure actions applied to particular users may be highly targeted and specific to particular characteristics of a particular user, thus helping the disclosed embodiments to provide the most effective and custom tailored cure actions for each individual user.

Other input metrics may relate to characteristics of the network itself. These may include network span (shortest path distances), network density (clustering coefficient) propensity to churn, in degree and out degree (number of in coming and out going links). Some example input metrics may include connection frequency of a user (how frequently a user uses the network to establish communication with a second user of the network), connection type (voice, video, text, email), direction (whether the user's communication may be characterized by communication from the user or to the user. This may be represented in some embodiments, by a ratio between communication from and communication to the user). The direction may also be known as in degree and/or out degree. In some aspects, the input may include all communication flows relating to a particular user over a time period. In various embodiments, the time period may be any of one hour, one day, one week, one month, one year, or any time period.

The trained model 306a-d may generate a cure action based on the input metrics. Each of the trained models 306a-d shown in FIG. 5B represent an ability for the model to evolve over time as the model learns which cure actions are most effective when applied to particular types of users under particular types of conditions.

Block 308 may apply the cure action. Results of the cure action applied by the action applier 308 is evaluated by the results evaluator 310. For example, the results evaluator may store a level of user engagement before the action is applied and for a period of time after the action is applied. Differences in the stored measurements of the level of user engagements indicate a level of effectiveness of the cure action.

The engagement health level and a subsequent engagement health level 555 may be provided to the results evaluator 310, which provides a loss value 560 to the trained model 306. The results evaluator 310 also provides a mapping between the loss value 560 and characteristics of a user (or user account) associated with the loss value. The results evaluator 310 also provides a mapping between the loss value, user characteristics, and cure action that was previously applied by the action applier 308. The trained model 306a-d may form one or more correlations between the input metrics it receives over time (defining characteristics of users), cure actions it generates for those users, and an associated resulting loss 560, representing an effectiveness of the cure actions. The model 306 may be configured to maximize the effectiveness of the cure actions.

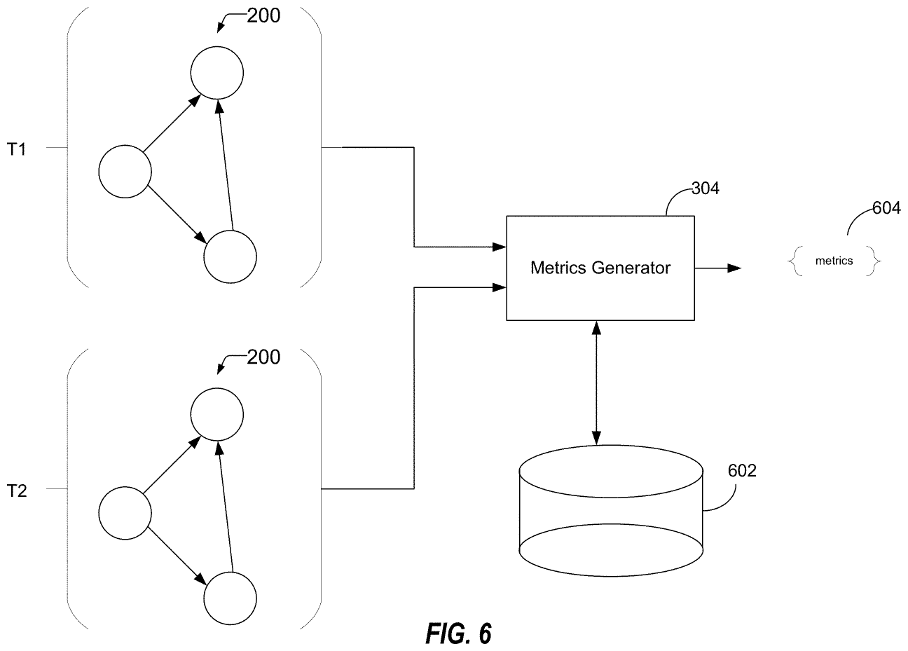

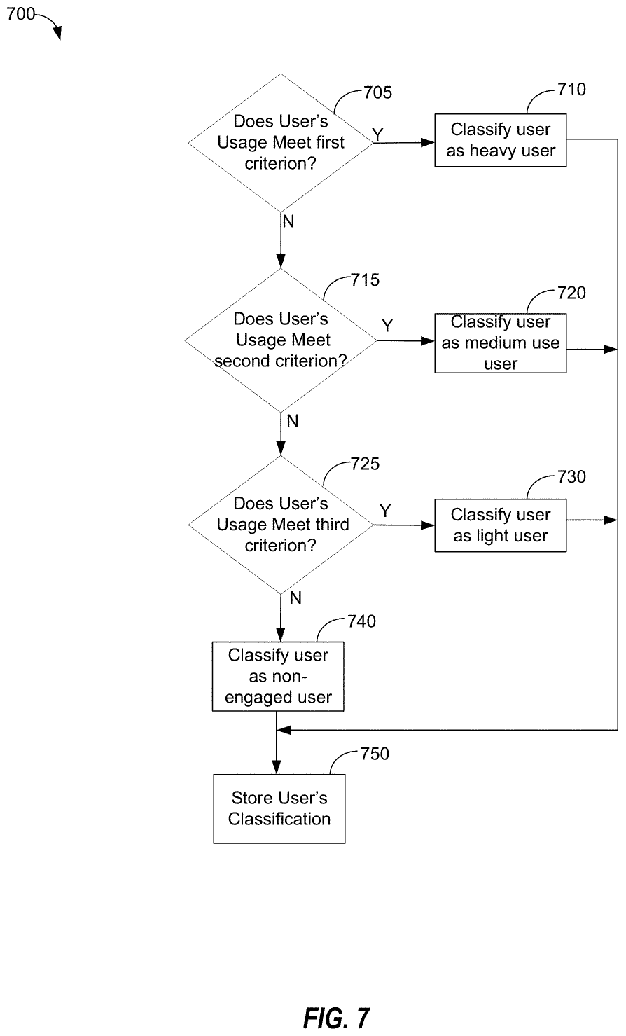

FIG. 6 shows an expanded data flow that may be implemented in at least some embodiments. FIG. 6 shows a first version of the graph 200 (shown as 200a) at a time T1. FIG. 6 also shows a second version of the graph 200 (shown as 200b) at a time T2. The metrics generator 304 may read data from each of the graphs 200a and 200b and store information relating to the graphs 200a-b in a database 602. By storing information from each of the graphs 200a-b over a period of time (T1-T2), the metrics generator 304 may be able to determine how data changes within the graph over time. For example, the metrics generator 304 may determine whether a particular user is becoming more or less engaged with the network 100 over time by comparing data captured at T1 versus data captured at T2. The metrics generator 304 may then generate metrics 604. The metrics 604 may be provided to the model 306. The metrics 604 may include a classification of a particular user. For example, as discussed below with respect to FIG. 7, a user's level of activity at a particular time may be classified as heavy, medium, light, or non-engaged, based on a number of criterion. The particular user's classification may then be compared across time, to determine if the user's level of engagement is increasing or decreasing over time. As discussed below, this may be used to initiate certain remedial actions to increase the user's engagement if needed. The metrics 604 may also include a number of reachable users for each user. In other words, the metrics generator may calculate, for each user, a number of other users within the user's contact list that are reachable via the network 100. The higher this number, the more likely the user is to remain engaged with the computer network 100. Thus, in some aspects, if the number of reachable users is below a threshold, some remedial action may be initiated. The metrics 604 may also identify a connection frequency for one or more users. The connection frequency may define a rate at which a user connects to another user via the network 100. The metrics 604 may also include a connection type for a particular user. For example, the connection type may define a speed of the user's connection to the network 100. The metrics 604 may include a direction indication for a particular user. In other words, the metrics 604 may indicate whether a user typically receives or typically initiates connections over the network 100. The metrics may also identify a most frequent target connection for a user. For example, a user may connect to a particular other user more frequently than other users. The metrics 606 may be provided to the model 306. These metrics may be utilized individually or separately.

FIG. 7 is a flowchart of one example method for classifying a level of engagement health of a user account. The user may be one of the users 102a-g discussed above with respect to FIG. 1. In some aspects, one or more of the functions discussed below with respect to process 700 and FIG. 7 may be performed by the machine 1100, discussed below. For example, instructions 1124 may configure the hardware processor 1102 to perform the functions.

Decision operation 705 determines whether usage by the user of the computer network 100 meets a first criterion. In some aspects, in order to meet the first criterion, the user must complete three connections over the network per day, and this must occur at least four times per week. The first criterion may differ in various embodiments. If the first criterion is met, process 700 moves from decision operation 705 to operation 710, where the user is classified as a heavy user. Otherwise, process 700 moves to decision operation 715, which determines whether the user's usage meets a second criterion. In some aspects, the second criterion may be met if the user completes three circuits per week. The second criterion may vary by embodiment. If the second criterion is met, process 700 moves to operation 720, which classifies the user as a medium user. Otherwise, process 700 moves to decision block 725, which evaluates whether the user's usage meets a third criterion. In some aspects, the third criterion is met if the user completes one circuit per week. The third criterion may vary by embodiment. If the third criterion is met, process 700 moves from decision block 725, to block 730, which classifies the user as a light user. Otherwise, process 700 moves from decision operation 725 to operation 740, which classifies the user as a non-engaged user.

While process 700 discussed above with respect to FIG. 7 shows three levels of user engagement, some embodiments may provide additional levels of user engagement. For example, some embodiments may determine a user engagement between a value of zero and 100, representing 100 different levels of user engagement.

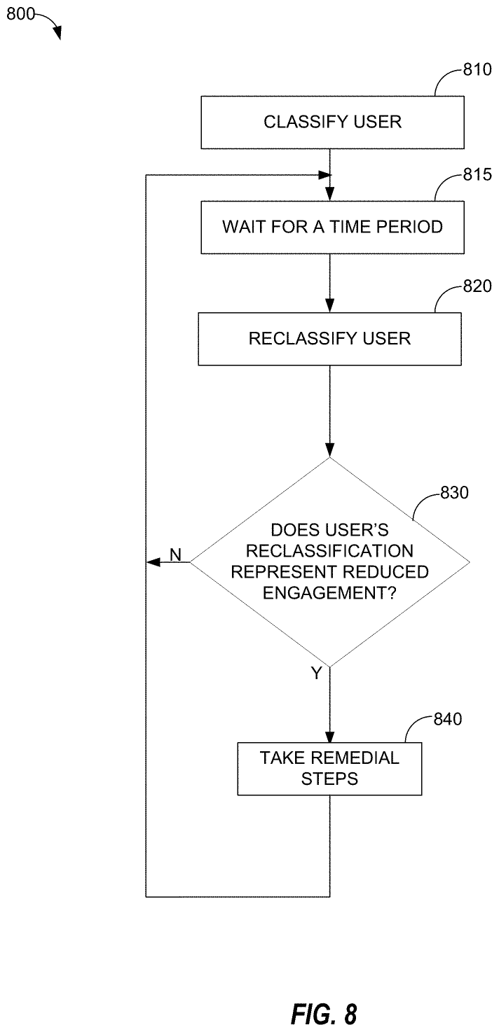

FIG. 8 is a flowchart of one example method for periodically classifying a user and taking remedial action. As discussed above, some embodiments disclosed may use machine learning to determine a cure action for a user account based on tracking a level of engagement health. Other embodiments may not rely on machine learning implementations, but instead may rely on traditional logic based implementations. In some aspects, one or more of the functions discussed below with respect to process 800 and FIG. 8 may be performed by the machine 1100, discussed below. For example, instructions 1124 may configure the processor 1102 to perform one or more of the functions discussed below.

In operation 810, a user is classified. In some aspects, option 810 may invoke process 700, discussed above with respect to FIG. 7 to classify the user. Operation 815 waits for a defined period of time. For example, in some aspects, operation 815 may wait for one week or one month, or some other time period in various embodiments.

In operation 820, the user is reclassified. In some aspects, operation 820 may invoke process 700, discussed above with respect to FIG. 7, to reclassify the user.

Decision operation 830 determines whether the reclassified user of block 820, indicates reduced engagement relative to the previous classification (in a first iteration of process 800, the previous classification is performed by operation 810. In subsequent iterations, the previous classification is performed by a previous iteration of operation 820. Reduced engagement may be indicated if the previous classification classified the user as a heavy user and a subsequent classification classified the user as either a medium use user (e.g., operation 720) or a light user (e.g., operation 730), or a non-engaged user (e.g., operation 740). If the usage indicates reduced engagement, process 800 moves to operation 840, which takes remedial steps to improve engagement. In some aspects, option 840 may provide in application messaging to the user. For example, a client application running on a client device may display messages to the use in an effort to increase engagement. In some aspects, operation 840 may apply one or more criterion indicated by the criterion table 460. As described above with respect to FIG. 4B, if particular criterion evaluate to a true condition, weights associated with those criterion may be compared to select a particular cure action 454. The cure action 454 may then be performed by operation 840.

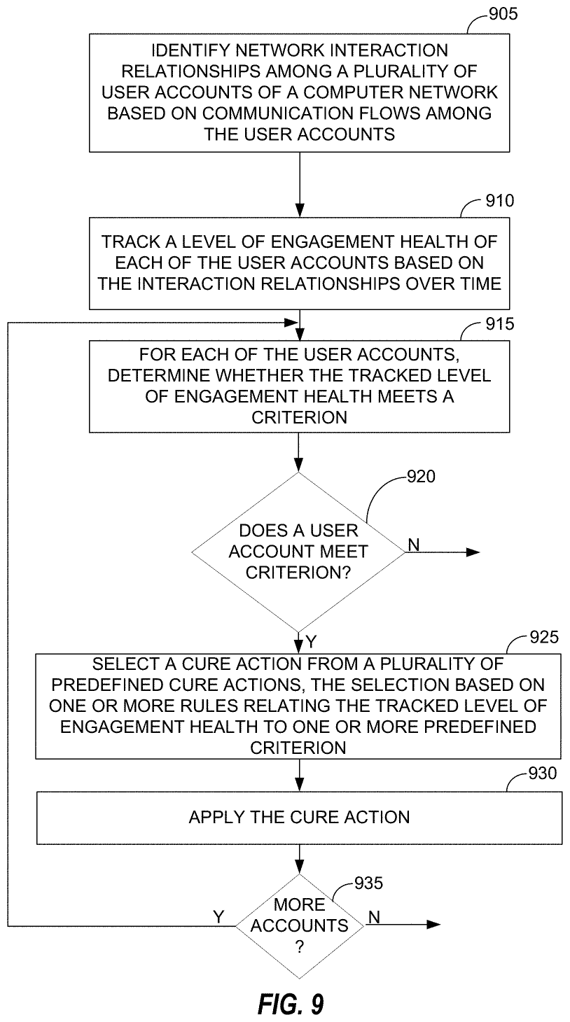

FIG. 9 is a flowchart of an example method for performing a cure action for a user account based on tracking of a level of engagement health of the user account. In some aspects, one or more of the functions discussed below with respect to process 900 and FIG. 9 may be performed by the machine 1100, discussed below. For example, instructions 1124 may configure the processor 1102 to perform one or more of the functions discussed below with respect to FIG. 9.

In operation 905, network interaction relationships are identified among a plurality of user accounts of a computer network. The interaction relationships are identified based on communication flows among the user accounts. For example, as discussed above, the network activity monitor 302 may provide info that may be represented in a data structure, such as the graph 200. Some aspects of operation 905 include generating a data structure. The data structure may be generated to include a node for each unique user account in the plurality of user accounts, and edges representing the plurality of communication flows. The edges may directionally connect nodes representing source user accounts for communication flows to nodes representing destination user accounts for the communication flows. Each edge may further represent a number of communication flows in the represented direction between the directionally connected nodes.

In operation 910, a level of engagement health of each of the user accounts is tracked based on the interaction relationships over time. In some aspects, the level of engagement health may be tracked based on the data structure described above with respect to operation 905. In some aspects, operation 910 may include performing process 700, discussed above with respect to FIG. 7 for each user to classify the user's level of engagement health (via, for example, 710, 720, and 730). This level of engagement health may be obtained for each user account based on the interaction relationships of the user account. The interaction relationships may be represented via the data structure discussed above (e.g., graph 200). Each level of engagement health may have a defined position in an ordered list of engagement levels. For example, a level of engagement health may be selected from an ordered set of engagement health levels such as highly engaged (e.g. operation 710), medium level of engagement (e.g. operation 720), low level of engagement (e.g. 730), no engagement (e.g. 740).

In some aspects, operation 910 may obtain a level of engagement health from a trained model. For example, as discussed above, in some aspects, one or more metrics derived from a data structure representing the interaction relationships, such as the graph 200, may be provided to the trained model. The trained model may determine the level of engagement health based on the interaction relationships.

In some aspects, the level of engagement health may be determined for a particular user account based on an amount of communication flows from and to the particular user account within a defined time period. For example, as discussed above, a data structure, such as the graph 200, may represent communication flows via edges of the graph. The metrics generator 304 may determine one or more metrics based on an amount of communication flows from and/or to a particular user account. In some aspects, a ratio of communication flows from/to a particular user account may be used to classify the user account as a leader account. For example, if a user account generates many more flows than it receives, the account may be classified as a leader account. Leader accounts may be treated differently than other accounts. For example, if a leader account were to become less engaged, an impact to the network communication system may be greater than if a non-leader account were to be less engaged.

Some aspects may determine an intensity of communication over time based on the interaction relationships, with the level of engagement health based on the intensity. The intensity may be based on a volume of communication flows to and from each user account over the time. The tracking of the level of engagement health of each user account is based on the intensity of communication of the respective user account.

In operation 915, a level of engagement health for each of the plurality of user accounts is compared with one or more criterion to determine if the level of engagement health meets the criterion. In some aspects, operation 915 compares levels of engagement health of each user across time. A decrease in engagement level within the ordered list of engagement health levels discussed above may correspond to a decrease in the level of engagement health.

Decision operation 920 determines whether the criterion is met for a particular user account. If the criterion is not met for a particular account, process 900 moves from decision operation 920 to operation 925, where a cure action is selected from a plurality of predefined cure actions. The selection is based on one or more rules relating the tracked level of engagement health to one or more predefined criteria. In some aspects, different rules may be used to select cure actions for different types of user accounts. For example, if a user account is classified as a leader account, a first set of rules may be used to determine a cure action. This set of rules may be somewhat more aggressive than a second set of rules used to select cure actions for non-leader accounts.

In some aspects, the cure action is selected by a model. As discussed above, some implementations may make use of one or more learning models, such as a neural network or classifier, to select a cure action based on user behavior, which may be represented by network data flows to and/or from the user. The model may be trained over time by providing the model with data flows from a plurality of users of the communications system. The model may also be provided with loss information, such as a level of each user's engagement over time. The model may then establish relationships between particular sets of user behavior, represented by the user data flows provided by the model, and particular engagement levels. The model may be configured to select cure actions that increase the engagement level, based on experience with prior users, where particular cure actions were applied, and generated positive changes in engagement levels.

To provide for continual refinement and adaptation of the model, some set of cure actions may be continuously provided to users of the social network. Thus, training of the model may change weights that control a proportion in which these various cure actions are applied to users fitting a particular behavior pattern or characterization. However, these weights may not be modified so as to eliminate the application of any one of the cure actions within the set of cure actions (e.g. change its proportional allocation to zero). This provides for feedback to be continuously obtained as to the effectiveness of each cure action in the set of cure actions, even if some of those cure actions are disfavored or currently judged to be ineffective. By continuing to apply some cure actions despite their relative lack of effectiveness, the system is able to continuous monitor the effectiveness of these cure actions, and in the event that the effectiveness of these cure actions improves over time, may begin to apply these cure actions in a greater proportion. If particular cure actions judged ineffective at a particular time were not applied at all, no further feedback would be received. If conditions changed such that those cure actions became more effective, the system would be unable to detect these changes. Thus, as discussed above, the system may continue to apply some relatively ineffective cure actions in a proportion to other cure actions that is greater than zero.

In operation 930, the selected action is applied to the user account. Applying the cure action may include scheduling an automated bot to place a call to a number associated with the particular user account and conduct a survey based on the level of engagement health for the particular user account. Applying the cure action may alternatively include sending one or more of a text message, email message, or social network message to the user. In some embodiments, a client application running on a device associated with the user may display messages within the application itself. For example, the application may be configured to display a banner or pop up notification indicating a message defined by the selected cure action.

Decision operation 935 determines if there are additional user accounts to process, and if so, processing returns to decision block 915.

Some aspects of process 900 measure a subsequent level of engagement health after the selected cure action is applied to the user account. The subsequent level of engagement may be compared to a prior level of engagement before the cure action was applied to determine whether the cure action was effective. For example, effectiveness may relate to whether the subsequent level of engagement health is increased relative to the prior level of engagement health. In some aspects, the rules discussed above may be modified based on the results. For example, for rules that apply one or more criterion for the particular cure action applied, weights associated with that cure action may be modified so it is selected less frequently or under different circumstances than those used to select it for the particular user account.

Some aspects may further train the trained model by providing an indicator of the selected cure action for a particular user account and the subsequent level of engagement health of the particular user account to the trained model. A loss function associated with the trained model may measure results of the cure action based on the prior and subsequent level of engagement health.

Some aspects of operation 900 may classify a relationship between two user accounts in the plurality of user accounts as important based on an amount of communication flows between the two user accounts meeting a criterion (e.g. greater than a threshold amount within a defined time period). Upon detection of a communication from one of the two user accounts to the other of the two user accounts, the communication may be highlighted in a user interface of the other of the two user accounts based on the classification. The highlighting of the communication may include sending a renotification to the other of the two user accounts in response to the communication remaining unread for greater than a threshold period of time.

Some aspects of operation 900 identify a periodicity of communication between two user accounts in the plurality of user accounts based on the interaction relationships. A gap in communication that violates the periodicity may be identified. The selecting of the cure action may be based on the identification of the gap. For example, the rules associated with particular cure actions may include criterion that identify the periodicity and/or the gap.

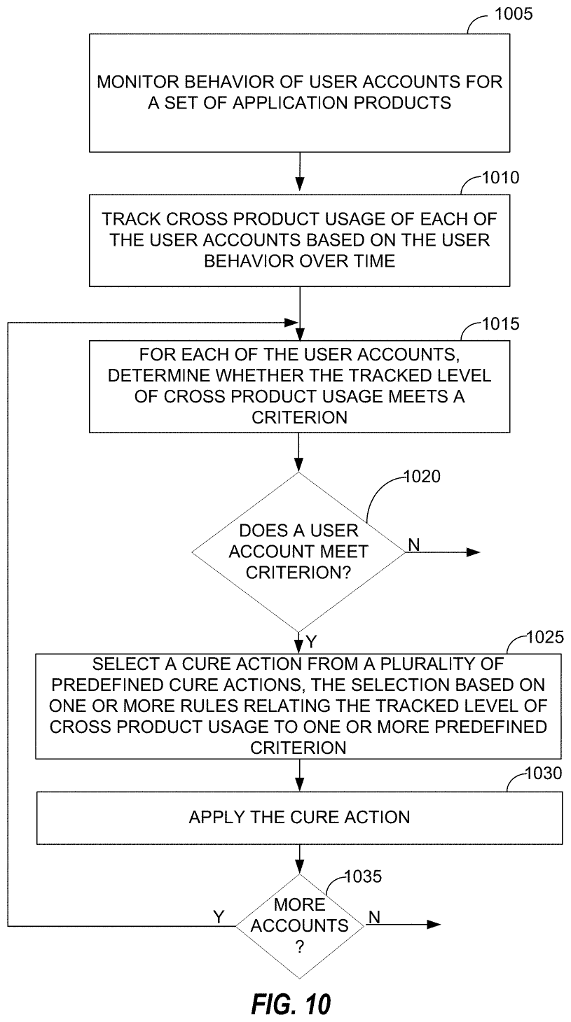

FIG. 10 is a flowchart of an example method for performing a cure action for a user account based on tracking of a level of engagement health of the user account. In some aspects, one or more of the functions discussed below with respect to process 1000 and FIG. 10 may be performed by the machine 1100, discussed below. For example, instructions 1124 may configure the processor 1102 to perform one or more of the functions discussed below with respect to FIG. 10.

In operation 1005, a behavior of one or more user accounts is monitored. The behavior may relate to usage of a set of products. The products may be delivered to the user accounts via a corresponding client applications. Each of the client applications may monitor user behavior. For example, each client application may record how frequently the product or application is used by a user and how it is used. Metrics recording this monitoring may be provided to a back-end system for further processing. In some aspects, operation 1005 may also include monitoring network communication flows from devices upon which each of the products or client application are installed. This information may also be provided to the back-end system.

In operation 1010, cross product usage is tracked for each of the user accounts based on the monitored behavior. The cross product usage may be tracked over time. For example, metrics representing cross product usage over a first time period, a second time period, and a third time period may be generated. In some aspects, the time periods may overlap but be of varying length. For example, the time periods may be one day, seven days, and one month in some embodiments.

In operation 1015, a determination is made as to whether the tracked level of cross product usage meets a criterion. In some aspects, operation 1015 may be accomplished by a model, such as a neural network or classifier. In some aspects, operation 1015 may be implemented via a rules engine. In some aspects that utilize a model based implementation, the model may be trained to store relationships between user behavior and increased cross product usage. The model may then associate particular actions with desirable user behavior that can increase cross product usage. As there may be a relationship between cross product usage and increased revenue provided to a provider of the products, some embodiments may optimize the model so as to provide actions that result in an increase in cross product usage.

Decision block 1020 evaluates whether the user account meets the criterion. If it does meet the criterion, then a cure action is applied to the user account in operations 1025 and 1030. As discussed above, the cure action may be designed to increase cross product usage by the user. In some aspects, the cure action may include messaging the user. The messaging may be accomplished via a variety of techniques, such as in application messages, email, text, or other messaging technology. The messaging may, for example, highlight particular features of a first product that relate to a feature of a second product the user is activity using. By emphasizing synergy between a user's demonstrated use of the second product (via the monitoring of operation 1005 for example,

Decision block 1035 evaluates whether additional user accounts are to be processed. If there are additional user accounts, process 1000 returns to operation 1015, and a next user account is considered.

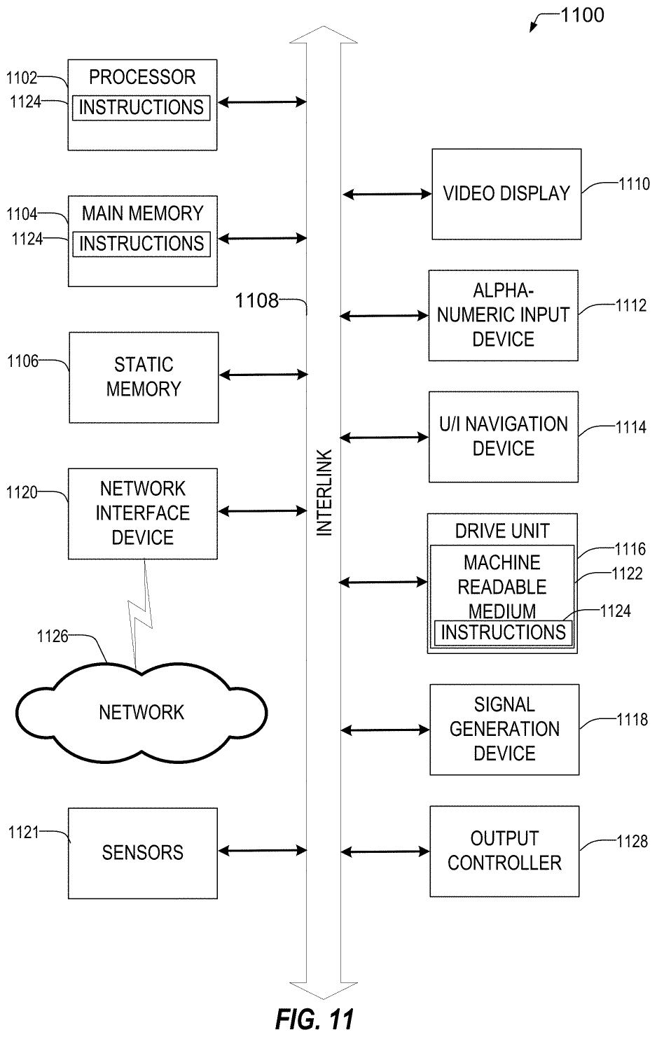

FIG. 11 illustrates a block diagram of an example machine 1100 upon which any one or more of the techniques (e.g., methodologies) discussed herein may perform. In alternative embodiments, the machine 1100 may operate as a standalone device or may be connected (e.g., networked) to other machines. In a networked deployment, the machine 1100 may operate in the capacity of a server machine, a client machine, or both in server-client network environments. In an example, the machine 1100 may act as a peer machine in peer-to-peer (P2P) (or other distributed) network environment. The machine 1100 may be a personal computer (PC), a tablet PC, a set-top box (STB), a personal digital assistant (PDA), a mobile telephone, a smart phone, a web appliance, a network router, switch or bridge, a server computer, a database, conference room equipment, or any machine capable of executing instructions (sequential or otherwise) that specify actions to be taken by that machine. Machine 1100 may implement, in whole or in part, the any one of the network activity monitor 302, metrics generator 304, trained model 306, or the results evaluator 310. In various embodiments, machine 1100 may perform one or more of the processes described above with respect to FIGS. 1-10. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms (all referred to hereinafter as “modules”). Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Machine (e.g., computer system) 1100 may include a hardware processor 1102 (e.g., a central processing unit (CPU), a graphics processing unit (GPU), a hardware processor core, or any combination thereof), a main memory 1104 and a static memory 1106, some or all of which may communicate with each other via an interlink (e.g., bus) 1108. The machine 1100 may further include a display unit 1110, an alphanumeric input device 1112 (e.g., a keyboard), and a user interface (UI) navigation device 1114 (e.g., a mouse). In an example, the display unit 1110, input device 1112 and UI navigation device 1114 may be a touch screen display. The machine 1100 may additionally include a storage device (e.g., drive unit) 1116, a signal generation device 1118 (e.g., a speaker), a network interface device 1120, and one or more sensors 1121, such as a global positioning system (GPS) sensor, compass, accelerometer, or other sensor. The machine 1100 may include an output controller 1128, such as a serial (e.g., universal serial bus (USB), parallel, or other wired or wireless (e.g., infrared(IR), near field communication (NFC), etc.) connection to communicate or control one or more peripheral devices (e.g., a printer, card reader, etc.).

The storage device 1116 may include a machine readable medium 1122 on which is stored one or more sets of data structures or instructions 1124 (e.g., software) embodying or utilized by any one or more of the techniques or functions described herein. The instructions 1124 may also reside, completely or at least partially, within the main memory 1104, within static memory 1106, or within the hardware processor 1102 during execution thereof by the machine 1100. In an example, one or any combination of the hardware processor 1102, the main memory 1104, the static memory 1106, or the storage device 1116 may constitute machine readable media.

While the machine readable medium 1122 is illustrated as a single medium, the term “machine readable medium” may include a single medium or multiple media (e.g., a centralized or distributed database, and/or associated caches and servers) configured to store the one or more instructions 1124.

The term “machine readable medium” may include any medium that is capable of storing, encoding, or carrying instructions for execution by the machine 1100 and that cause the machine 1100 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks. In some examples, machine readable media may include non-transitory machine readable media. In some examples, machine readable media may include machine readable media that is not a transitory propagating signal.

The instructions 1124 may further be transmitted or received over a communications network 1126 using a transmission medium via the network interface device 1120. The machine 1100 may communicate with one or more other machines utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others. In an example, the network interface device 1120 may include one or more physical jacks (e.g., Ethernet, coaxial, or phone jacks) or one or more antennas to connect to the communications network 1126. In an example, the network interface device 1120 may include a plurality of antennas to wirelessly communicate using at least one of single-input multiple-output (SIMO), multiple-input multiple-output (MIMO), or multiple-input single-output (MISO) techniques. In some examples, the network interface device 1120 may wirelessly communicate using Multiple User MIMO techniques.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client, or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations.

Example 1 is a method for applying cure actions to an account, comprising: identifying network interaction relationships among a plurality of accounts of a computer network based on communication flows among the accounts; tracking a level of engagement health of each of the accounts based on the interaction relationships over time; for each of the accounts, determining whether the tracked level of engagement health meets a threshold requirement; and for an account having a level of engagement health not meeting the threshold requirement: selecting a cure action from a plurality of predefined cure actions, each predefined cure action selected based on one or more rules relating the tracked level of engagement health to one or more predefined criteria, and applying the cure action to the account having the level of engagement health not meeting the threshold requirement.

In Example 2, the subject matter of Example 1 optionally includes providing data derived from the interaction relationships for each of the accounts to a trained model and receiving an indicator of a level of engagement health for each of the accounts from the trained model.

In Example 3, the subject matter of Example 2 optionally includes training the trained model by providing an indicator of a selected cure action for a particular account and a subsequent level of engagement health of the particular account to the trained model, wherein the trained model is configured to adapt the rules based on the measuring.

In Example 4, the subject matter of any one or more of Examples 1-3 optionally include determining a level of engagement health for a particular account based on an amount of communication flows from and to the particular account within a defined time period.

In Example 5, the subject matter of any one or more of Examples 1-4 optionally include wherein tracking the level of engagement health of each of the accounts comprises: categorizing a level of engagement health of each account of the plurality of accounts based on interaction relationships of the account, each engagement health level including a defined position in an ordered list of engagement health levels; and comparing engagement health levels of each user across time, wherein a decrease in engagement health level within the ordered list of engagement levels corresponds to a decrease in the level of engagement health.

In Example 6, the subject matter of any one or more of Examples 1-5 optionally include classifying each account as either a leader account or a non-leader account based on the interaction relationships, wherein the selection of a cure action for a particular account is according to a first set of rules if the particular account is a leader account and a second set of rules otherwise.

In Example 7, the subject matter of Example 6 optionally includes wherein the classification of each account is based on a ratio of communication flows to the account versus communication flows from the account.

In Example 8, the subject matter of any one or more of Examples 1-7 optionally include determining an intensity of communication for each of the accounts over the time based on a volume of communication flows to and from each account over the time, wherein the tracking of the level of engagement health of each account is based on the intensity of communication of the respective account.

In Example 9, the subject matter of any one or more of Examples 1-8 optionally include classifying a relationship between two accounts in the plurality of accounts as important based on an amount of communication flows between the two accounts meeting a criterion, detecting a communication from one of the two accounts to the other of the two accounts, and highlighting the communication in a user interface of the other of the two accounts based on the classification.

In Example 10, the subject matter of Example 9 optionally includes wherein highlighting the communication comprises sending a renotification to the other of the two accounts in response to the communication remaining unread for greater than a threshold period of time.

In Example 11, the subject matter of any one or more of Examples 1-10 optionally include identifying a periodicity of communication between two accounts in the plurality of accounts based on the interaction relationships, identifying a gap in communication that violates the periodicity, wherein the selecting of the cure action is based on the identification of the gap.

In Example 12, the subject matter of any one or more of Examples 1-11 optionally include wherein a selected action for the particular account comprises scheduling an automated bot to place a call to a number associated with the particular account and conduct a survey based on the level of engagement health for the particular account.

In Example 13, the subject matter of any one or more of Examples 1-12 optionally include wherein the identifying of interaction relationships comprises generating a data structure, the data structure including a node for each unique account in the plurality of accounts, and edges representing the plurality of communication flows and directionally connecting nodes representing source accounts for communication flows to nodes representing destination accounts for the communication flows, each edge further representing a number of communication flows in the represented direction between the directionally connected nodes, wherein the tracking of the level of health is based on the data structure.

Example 14 is a system for applying cure actions to an account, comprising: hardware processing circuitry; one or more hardware memories storing instructions that when executed configure the hardware processing circuitry to perform operations comprising: identifying network interaction relationships among a plurality of accounts of a computer network based on communication flows among the accounts; tracking a level of engagement health of each of the accounts based on the interaction relationships over time; for each of the accounts, determining whether the tracked level of engagement health meets a threshold requirement; for an account having a level of engagement health not meeting the threshold requirement: selecting a cure action from a plurality of predefined cure actions, each predefined cure action selected based on one or more rules relating the tracked level of engagement health to one or more predefined criteria, and applying the cure action to the account having the level of engagement health not meeting the threshold requirement.

In Example 15, the subject matter of Example 14 optionally includes the operations further comprising providing data derived from the interaction relationships for each of the accounts to a trained model and receiving an indicator of a level of engagement health for each of the accounts from the trained model.

In Example 16, the subject matter of Example 15 optionally includes the operations further comprising training the trained model by providing an indicator of a selected cure action for a particular account and a subsequent level of engagement health of the particular account to the trained model, wherein the trained model is configured to adapt the rules based on the measuring.

In Example 17, the subject matter of any one or more of Examples 14-16 optionally include the operations further comprising determining a level of engagement health for a particular account based on an amount of communication flows from and to the particular account within a defined time period.

In Example 18, the subject matter of any one or more of Examples 14-17 optionally include wherein tracking the level of engagement health of each of the accounts comprises: categorizing a level of engagement health of each account of the plurality of accounts based on interaction relationships of the account, each engagement health level including a defined position in an ordered list of engagement health levels; and comparing engagement health levels of each user across time, wherein a decrease in engagement health level within the ordered list of engagement levels corresponds to a decrease in the level of engagement health.

In Example 19, the subject matter of any one or more of Examples 14-18 optionally include the operations further comprising classifying each account as either a leader account or a non-leader account based on the interaction relationships, wherein the selection of a cure action for a particular account is according to a first set of rules if the particular account is a leader account and a second set of rules otherwise.

In Example 20, the subject matter of Example 19 optionally includes wherein the classification of each account is based on a ratio of communication flows to the account versus communication flows from the account.

In Example 21, the subject matter of any one or more of Examples 14-20 optionally include the operations further comprising determining an intensity of communication for each of the accounts over the time based on a volume of communication flows to and from each account over the time, wherein the tracking of the level of engagement health of each account is based on the intensity of communication of the respective account.

In Example 22, the subject matter of any one or more of Examples 14-21 optionally include the operations further comprising classifying a relationship between two accounts in the plurality of accounts as important based on an amount of communication flows between the two accounts meeting a criterion, detecting a communication from one of the two accounts to the other of the two accounts, and highlighting the communication in a user interface of the other of the two accounts based on the classification.

In Example 23, the subject matter of Example 22 optionally includes wherein highlighting the communication comprises sending a renotification to the other of the two accounts in response to the communication remaining unread for greater than a threshold period of time.

In Example 24, the subject matter of any one or more of Examples 14-23 optionally include the operations further comprising identifying a periodicity of communication between two accounts in the plurality of accounts based on the interaction relationships, identifying a gap in communication that violates the periodicity, wherein the selecting of the cure action is based on the identification of the gap.

In Example 25, the subject matter of any one or more of Examples 14-24 optionally include wherein a selected action for the particular account comprises scheduling an automated bot to place a call to a number associated with the particular account and conduct a survey based on the level of engagement health for the particular account.

In Example 26, the subject matter of any one or more of Examples 14-25 optionally include wherein the identifying of interaction relationships comprises generating a data structure, the data structure including a node for each unique account in the plurality of accounts, and edges representing the plurality of communication flows and directionally connecting nodes representing source accounts for communication flows to nodes representing destination accounts for the communication flows, each edge further representing a number of communication flows in the represented direction between the directionally connected nodes, wherein the tracking of the level of health is based on the data structure.

Example 27 is a non-transitory computer readable storage medium comprising instructions that when executed configure hardware processing circuitry to perform operations comprising: identifying network interaction relationships among a plurality of accounts of a computer network based on communication flows among the accounts; tracking a level of engagement health of each of the accounts based on the interaction relationships over time; for each of the accounts, determining whether the tracked level of engagement health meets a threshold requirement; for an account having a level of engagement health not meeting the threshold requirement: selecting a cure action from a plurality of predefined cure actions, each predefined cure action selected based on one or more rules relating the tracked level of engagement health to one or more predefined criteria, and applying the cure action to the account having the level of engagement health not meeting the threshold requirement.

In Example 28, the subject matter of Example 27 optionally includes the operations further comprising providing data derived from the interaction relationships for each of the accounts to a trained model and receiving an indicator of a level of engagement health for each of the accounts from the trained model.

In Example 29, the subject matter of Example 28 optionally includes the operations further comprising training the trained model by providing an indicator of a selected cure action for a particular account and a subsequent level of engagement health of the particular account to the trained model, wherein the trained model is configured to adapt the rules based on the measuring.

In Example 30, the subject matter of any one or more of Examples 27-29 optionally include the operations further comprising determining a level of engagement health for a particular account based on an amount of communication flows from and to the particular account within a defined time period.

In Example 31, the subject matter of any one or more of Examples 27-30 optionally include wherein tracking the level of engagement health of each of the accounts comprises: categorizing a level of engagement health of each account of the plurality of accounts based on interaction relationships of the account, each engagement health level including a defined position in an ordered list of engagement health levels; and comparing engagement health levels of each user across time, wherein a decrease in engagement health level within the ordered list of engagement levels corresponds to a decrease in the level of engagement health.

In Example 32, the subject matter of any one or more of Examples 27-31 optionally include the operations further comprising classifying each account as either a leader account or a non-leader account based on the interaction relationships, wherein the selection of a cure action for a particular account is according to a first set of rules if the particular account is a leader account and a second set of rules otherwise.

In Example 33, the subject matter of Example 32 optionally includes wherein the classification of each account is based on a ratio of communication flows to the account versus communication flows from the account.

In Example 34, the subject matter of any one or more of Examples 27-33 optionally include the operations further comprising determining an intensity of communication for each of the accounts over the time based on a volume of communication flows to and from each account over the time, wherein the tracking of the level of engagement health of each account is based on the intensity of communication of the respective account.

In Example 35, the subject matter of any one or more of Examples 27-34 optionally include the operations further comprising classifying a relationship between two accounts in the plurality of accounts as important based on an amount of communication flows between the two accounts meeting a criterion, detecting a communication from one of the two accounts to the other of the two accounts, and highlighting the communication in a user interface of the other of the two accounts based on the classification.

In Example 36, the subject matter of Example 35 optionally includes wherein highlighting the communication comprises sending a renotification to the other of the two accounts in response to the communication remaining unread for greater than a threshold period of time.

In Example 37, the subject matter of any one or more of Examples 27-36 optionally include the operations further comprising identifying a periodicity of communication between two accounts in the plurality of accounts based on the interaction relationships, identifying a gap in communication that violates the periodicity, wherein the selecting of the cure action is based on the identification of the gap.

In Example 38, the subject matter of any one or more of Examples 27-37 optionally include wherein a selected action for the particular account comprises scheduling an automated bot to place a call to a number associated with the particular account and conduct a survey based on the level of engagement health for the particular account.

In Example 39, the subject matter of any one or more of Examples 27-38 optionally include wherein the identifying of interaction relationships comprises generating a data structure, the data structure including a node for each unique account in the plurality of accounts, and edges representing the plurality of communication flows and directionally connecting nodes representing source accounts for communication flows to nodes representing destination accounts for the communication flows, each edge further representing a number of communication flows in the represented direction between the directionally connected nodes, wherein the tracking of the level of health is based on the data structure.

Example 40 is an apparatus, comprising: means for identifying network interaction relationships among a plurality of accounts of a computer network based on communication flows among the accounts; means for tracking a level of engagement health of each of the accounts based on the interaction relationships over time; means for determining, for each of the accounts, whether the tracked level of engagement health meets a threshold requirement; means for performing, for an account having a level of engagement health not meeting the threshold requirement: selecting a cure action from a plurality of predefined cure actions, each predefined cure action selected based on one or more rules relating the tracked level of engagement health to one or more predefined criteria, and applying the cure action to the account having the level of engagement health not meeting the threshold requirement.

In Example 41, the subject matter of Example 40 optionally includes means for providing data derived from the interaction relationships for each of the accounts to a trained model and means for receiving an indicator of a level of engagement health for each of the accounts from the trained model.

In Example 42, the subject matter of Example 41 optionally includes means for training the trained model by providing an indicator of a selected cure action for a particular account and a subsequent level of engagement health of the particular account to the trained model, wherein the trained model is configured to adapt the rules based on the measuring.

In Example 43, the subject matter of any one or more of Examples 40-42 optionally include means for determining a level of engagement health for a particular account based on an amount of communication flows from and to the particular account within a defined time period.

In Example 44, the subject matter of any one or more of Examples 40-43 optionally include wherein the means for tracking the level of engagement health of each of the accounts is configured to: categorize a level of engagement health of each account of the plurality of accounts based on interaction relationships of the account, each engagement health level including a defined position in an ordered list of engagement health levels; and compare engagement health levels of each user across time, wherein a decrease in engagement health level within the ordered list of engagement levels corresponds to a decrease in the level of engagement health.

In Example 45, the subject matter of any one or more of Examples 40-44 optionally include means for classifying each account as either a leader account or a non-leader account based on the interaction relationships, wherein the means for selection of a cure action for a particular account is configured to select the cure action according to a first set of rules if the particular account is a leader account and a second set of rules otherwise.

In Example 46, the subject matter of Example 45 optionally includes wherein the means for classifying each account is configured to classify each account based on a ratio of communication flows to the account versus communication flows from the account.

In Example 47, the subject matter of any one or more of Examples 40-46 optionally include means for determining an intensity of communication for each of the accounts over the time based on a volume of communication flows to and from each account over the time, wherein the means for tracking the level of engagement health of each account is configured to track the level of engagement health for each account based on the intensity of communication of the respective account.

In Example 48, the subject matter of any one or more of Examples 40-47 optionally include means for classifying a relationship between two accounts in the plurality of accounts as important based on an amount of communication flows between the two accounts meeting a criterion, means for detecting a communication from one of the two accounts to the other of the two accounts, and means for highlighting the communication in a user interface of the other of the two accounts based on the classification.

In Example 49, the subject matter of Example 48 optionally includes wherein the means for highlighting the communication is configured to send a renotification to the other of the two accounts in response to the communication remaining unread for greater than a threshold period of time.

In Example 50, the subject matter of any one or more of Examples 40-49 optionally include means for identifying a periodicity of communication between two accounts in the plurality of accounts based on the interaction relationships, means for identifying a gap in communication that violates the periodicity, wherein the means for selecting of the cure action is configured to base the selection on the identification of the gap.

In Example 51, the subject matter of any one or more of Examples 40-50 optionally include wherein a selected action for the particular account comprises scheduling an automated bot to place a call to a number associated with the particular account and conduct a survey based on the level of engagement health for the particular account.

In Example 52, the subject matter of any one or more of Examples 40-51 optionally include wherein the means for identifying interaction relationships is configured to generate a data structure, the data structure including a node for each unique account in the plurality of accounts, and edges representing the plurality of communication flows and directionally connect nodes representing source accounts for communication flows to nodes representing destination accounts for the communication flows, each edge further representing a number of communication flows in the represented direction between the directionally connected nodes, wherein the means for tracking the level of health is configured to track the level of health based on the data structure.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; flash memory; etc.

We claim:

1. A system for applying cure actions to an account, comprising:
hardware processing circuitry;
one or more hardware memories storing instructions that when executed configure the hardware processing circuitry to perform operations comprising:
identifying network interaction relationships among a plurality of accounts of a computer network based on communication flows among the accounts;
tracking a level of engagement health of each of the accounts based on the interaction relationships over time;
for each of the accounts, determining whether the tracked level of engagement health meets a threshold requirement;
for an account having a level of engagement health not meeting the threshold requirement:
selecting a cure action from a plurality of predefined cure actions, each predefined cure action selected based on one or more rules relating the tracked level of engagement health of the account to one or more predefined criteria, and
applying the cure action to the account having the level of engagement health not meeting the threshold requirement.

2. The system of claim 1, the operations further comprising providing data derived from the interaction relationships for each of the accounts to a trained model and receiving an indicator of a level of engagement health for each of the accounts from the trained model.

3. The system of claim 2, the operations further comprising training the trained model by providing an indicator of a selected cure action for a particular account and a subsequent level of engagement health of the particular account to the trained model, wherein the trained model is configured to adapt the rules based on the measuring.

4. The system of claim 1, the operations further comprising determining a level of engagement health for a particular account based on an amount of communication flows from and to the particular account within a defined time period.

5. The system of claim 1, wherein tracking the level of engagement health of each of the accounts comprises:
categorizing a level of engagement health of each account of the plurality of accounts based on interaction relationships of the account, each engagement health level including a defined position in an ordered list of engagement health levels; and
comparing engagement health levels of each user across time, wherein a decrease in engagement health level within the ordered list of engagement levels corresponds to a decrease in the level of engagement health.

6. The system of claim 1, the operations further comprising classifying each account as either a leader account or a non-leader account based on the interaction relationships, wherein the selection of a cure action for a particular account is according to a first set of rules if the particular account is a leader account and a second set of rules otherwise.

7. The system of claim 6, wherein the classification of each account is based on a ratio of communication flows to the account versus communication flows from the account.

8. The system of claim 1, the operations further comprising determining an intensity of communication for each of the accounts over the time based on a volume of communication flows to and from each account over the time, wherein the tracking of the level of engagement health of each account is based on the intensity of communication of the respective account.

9. The system of claim 1, the operations further comprising classifying a relationship between two accounts in the plurality of accounts as important based on an amount of communication flows between the two accounts meeting a criterion, detecting a communication from one of the two accounts to the other of the two accounts, and highlighting the communication in a user interface of the other of the two accounts based on the classification.

10. The system of claim 9, wherein highlighting the communication comprises sending a renotification to the other of the two accounts in response to the communication remaining unread for greater than a threshold period of time.

11. The system of claim 1, the operations further comprising identifying a periodicity of communication between two accounts in the plurality of accounts based on the interaction relationships, identifying a gap in communication that violates the periodicity, wherein the selecting of the cure action is based on the identification of the gap.

12. The system of claim 1, wherein a selected action for the particular account comprises scheduling an automated bot to place a call to a number associated with the particular account and conduct a survey based on the level of engagement health for the particular account.

13. The system of claim 1, wherein the identifying of interaction relationships comprises generating a data structure, the data structure including a node for each unique account in the plurality of accounts, and edges representing the plurality of communication flows and directionally connecting nodes representing source accounts for communication flows to nodes representing destination accounts for the communication flows, each edge further representing a number of communication flows in the represented direction between the directionally connected nodes, wherein the tracking of the level of health is based on the data structure.

14. A method for applying cure actions to an account, comprising:
identifying network interaction relationships among a plurality of accounts of a computer network based on communication flows among the accounts;
tracking a level of engagement health of each of the accounts based on the interaction relationships over time;
for each of the accounts, determining whether the tracked level of engagement health meets a threshold requirement; and
for an account having a level of engagement health not meeting the threshold requirement:
selecting a cure action from a plurality of predefined cure actions, each predefined cure action selected based on one or more rules relating the tracked level of engagement health of the account to one or more predefined criteria, and
applying the cure action to the account having the level of engagement health not meeting the threshold requirement.

15. The method of claim 14, further comprising providing data derived from the interaction relationships for each of the accounts to a trained model and receiving an indicator of a level of engagement health for each of the accounts from the trained model.

16. The method of claim 15, further comprising training the trained model by providing an indicator of a selected cure action for a particular account and a subsequent level of engagement health of the particular account to the trained model, wherein the trained model is configured to adapt the rules based on the measuring.

17. The method of claim 14, further comprising determining a level of engagement health for a particular account based on an amount of communication flows from and to the particular account within a defined time period.

18. The method of claim 14, wherein tracking the level of engagement health of each of the accounts comprises:
categorizing a level of engagement health of each account of the plurality of accounts based on interaction relationships of the account, each engagement health level including a defined position in an ordered list of engagement health levels; and
comparing engagement health levels of each user across time, wherein a decrease in engagement health level within the ordered list of engagement levels corresponds to a decrease in the level of engagement health.

19. The method of claim 14, further comprising classifying each account as either a leader account or a non-leader account based on the interaction relationships, wherein the selection of a cure action for a particular account is according to a first set of rules if the particular account is a leader account and a second set of rules otherwise.

20. An apparatus, comprising:
means for identifying network interaction relationships among a plurality of accounts of a computer network based on communication flows among the accounts;
means for tracking a level of engagement health of each of the accounts based on the interaction relationships over time;
means for determining, for each of the accounts, whether the tracked level of engagement health meets a threshold requirement;
means for performing, for an account having a level of engagement health not meeting the threshold requirement:
selecting a cure action from a plurality of predefined cure actions, each predefined cure action selected based on one or more rules relating the tracked level of engagement health of the account to one or more predefined criteria, and
applying the cure action to the account having the level of engagement health not meeting the threshold requirement.
